(19) United States
(12) Patent Application Publication
(10) Pub. No.: US 2012/0064474 A1
(43) Pub. Date: Mar. 15, 2012

(54) Methods of Manufacturing a Convertible Orthodontic Bracket by Machining

(75) Inventors: Paul E. Lewis, Midvale, UT (US); Timothy V. Wood, South Jordan, UT (US); Michael J. Krumpelmann, Draper, UT (US)

(73) Assignee: Ultradent Products, Inc., South Jordan, UT (US)

(21) Appl. No.: 13/255,494

(22) PCT Filed: Mar. 11, 2010
(86) PCT No.: PCT/US10/27013

§ 371 Date: Nov. 29, 2011

Related U.S. Application Data
(60) Provisional application No. 61/159,864, filed on Mar. 13, 2009.

(51) Int. Cl. A61C 7/14; B21F 43/00

(52) U.S. Cl. 433/8; 29/896.11

(57) ABSTRACT

Convertible orthodontic brackets (100) with a selectively removable labial web (112) are formed by machining. A circular pilot hole is formed so as to extend mesially-distally through the body of the orthodontic bracket (100). One or more shaping broaches are then pushed or pulled through the pilot hole so as to form a desired rectangularly-shaped arch wire hole (106) within the orthodontic bracket body (104). The area surrounding the labial web cover (112) is also machined to form first and second connecting web regions (114, 116) of reduced cross-sectional thickness on either side of the labial web cover (112). Manufacture by machining allows stronger more dense metals to be employed compared to manufacturing by metal injection molding.

### BACKGROUND OF THE INVENTION

1. The Field of the Invention

The present invention relates to orthodontic brackets and related methods of manufacture.

2. The Relevant Technology

Orthodontics is a specialized field of dentistry that involves the application of mechanical forces to urge poorly positioned or crooked teeth into correct alignment and orientation. Orthodontic procedures can be used for cosmetic enhancement of teeth, as well as medically necessary movement of teeth to correct underbites or overbites. For example, orthodontic treatment can improve the patient's occlusion and/or enhanced spatial matching of corresponding teeth.

The most common form of orthodontic treatment involves the use of orthodontic brackets and wires, which together are commonly referred to as “braces.” Orthodontic brackets are small slotted bodies configured for direct attachment to the patient's teeth or, alternatively, for attachment to bands which are, in turn, cemented or otherwise secured around the teeth. Once the brackets are affixed to the patient's teeth, such as by means of glue or cement, a curved arch wire is inserted into the bracket slots. The arch wire acts as a template or track to guide movement of the teeth into proper alignment. End sections of the arch wire are typically captured within tiny appliances known as tube brackets or terminal brackets, which are affixed to the patient's bicuspids and/or molars. The remaining brackets typically include open arch wire slots and apply orthodontic forces by means of ligatures attached to the brackets and arch wire (e.g., by means of tie wings on the brackets).

Metallic orthodontic brackets are typically manufactured by a metal injection molding and sintering process, in which powdered metal is injected with a polymeric binder resin material to injection mold a green orthodontic body. The green body is thereafter sintered to drive off the binder, and cause the powdered metal particles to partially fuse and adhere together.

### BRIEF SUMMARY OF THE INVENTION

The present invention is directed to methods of manufacturing convertible orthodontic brackets that include a labial web cover which is selectively removable during orthodontic treatment. As such, the arch wire receptacle is a rectangular hole or tube closed on four sides rather than an open slot when the bracket is manufactured and during an early phase of treatment. According to the inventive manufacturing method, the arch wire hole is machined rather than formed by a metal injection molding and sintering process. At least one circular cross-sectioned pilot hole is formed so as to extend mesially-distally through the body of the orthodontic bracket. A shaping broach is then pushed or pulled through the pilot hole so as to form the desired rectangularly-shaped arch wire hole within the orthodontic bracket body. The area surrounding the labial web cover is also machined to form first and second connecting web regions of reduced cross-sectional thickness on either side of the labial web cover. These thinned connecting web regions facilitate orderly, predictable, and easy removal of the labial web cover when desired by the practitioner.

Such a machining method advantageously allows for the use of stronger, more dense metal materials (e.g., 17-4 and/or 17-7 class stainless steels). In addition, because the bulk metal material is not a sintered powder, the overall strength of the bracket manufactured according to the inventive method exhibits far greater strength and durability. For example, during a molding and sintering process, tiny voids can form within the body, thereby reducing strength. In addition, the strength of a sintered body is limited by the adhesion of the powder particles to one another after sintering. Finally, machining the brackets allows for tighter manufacturing tolerances, as molded and sintered brackets are known to shrink or otherwise deform an unpredictable amount during sintering. Narrower tolerances provide for better fit for the patient, which results in reduced overall treatment times.

The use of drill bits, end mills, and broaches including a carbide coating (e.g., titanium carbide and/or tungsten carbide) is particularly preferred, as they have been found to surprisingly allow formation of tiny pilot holes (e.g., typically less than 0.025 inch diameter) and rectangular finished arch wire holes (e.g., typically having a width less than about 0.025 inch) without breakage of the tools. The ability to form such tiny holes is surprising, as those skilled in the art previously would have expected this manufacturing method to be unworkable as a result of severe tool wear and/or tool breakage.

In preferred embodiments, multiple pilot holes may be formed and/or multiple broaches employed. Such methods have advantageously been found to greatly reduce tool wear on the drill bits, end mills, and shaping broaches used to form the pilot holes and finish the rectangularly shaped hole. The reduction in tool wear is even greater than would be expected simply as a result of using multiple tools to perform a task.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an exemplary convertible molar orthodontic bracket manufactured according to the present inventive method;

FIG. 1B is a perspective view of an exemplary convertible bicuspid orthodontic bracket manufactured according to the present inventive method;

FIG. 2 is a cross-sectional view through an intermediate orthodontic bracket body in which a pilot hole has been drilled mesially-distally through the body;

FIG. 3A is a cross-sectional view through the body of FIG. 2, in which a first shaping broach has been pushed or pulled through the pilot hole so as to partially form the rectangular cross-section of the finished arch wire hole;

FIG. 3B is a cross-sectional view of the body of FIG. 3A, in which a second shaping broach has been pushed or pulled through the top portion of what becomes the rectangular cross-sectioned arch wire hole;

FIG. 3C is a cross-sectional view of the body of FIG. 3B, in which a final broach has been pushed or pulled through the bottom portion of what becomes the rectangular cross-sectioned arch wire hole, completing the arch wire hole;

FIG. 4A is a cross-sectional view through an intermediate orthodontic bracket body in which a first pilot hole has been drilled mesially-distally through the body;

FIG. 4B is a cross-sectional view through the body of FIG. 4A, in which a second pilot hole offset from the first pilot hole has been drilled through the body;

FIG. 5A is a cross-sectional view through the body of FIG. 4B, in which a first shaping broach has been pushed or pulled through the first pilot hole so as to partially form the rectangular cross-section of the finished arch wire hole;

FIG. 5B is a cross-sectional view of the body of FIG. 5A, in which a final shaping broach has been pushed or pulled through the second pilot hole so as to complete formation of the rectangular cross-section of the finished arch wire hole;

FIG. 6A is a longitudinal cross-sectional view of an orthodontic body in which the first pilot hole is formed at an angle;

FIG. 6B is a transverse cross-sectional view of the body of FIG. 6A;

FIG. 6C is a longitudinal cross-sectional view of the body of FIG. 6A in which the second pilot hole is also formed at an angle, such that the axes of the two pilot holes cross one another;

FIG. 6D is a transverse cross-sectional view of the body of FIG. 6C;

FIG. 7A is a cross-sectional view the bracket of FIG. 1A, near a mesial edge of the bracket; and

FIG. 7B is a cross-sectional view of the bracket of FIG. 1A, near a distal edge of the bracket.

### DETAILED DESCRIPTION OF THE PREFERRED EMBODIMENTS

### I. Introduction

The present invention is directed to methods of manufacturing convertible orthodontic brackets, which include a selectively removable labial web cover that is removed (e.g., by peeling) intraorally by the practitioner part way through treatment. According to the inventive method of manufacture, a circular pilot hole may be formed so as to extend mesially-distally through the body of the orthodontic bracket. At least one shaping broach is then pushed or pulled through the pilot hole so as to form at least a portion of the desired rectangularly-shaped arch wire hole within the orthodontic bracket body. The area surrounding the labial web cover may also be machined to form first and second connecting web regions of reduced cross-sectional thickness on either side of the labial web cover. These thinned connecting web regions facilitate orderly, predictable, and easy peeling removal of the labial web cover when the practitioner desires.

### II. Exemplary Convertible Orthodontic Brackets

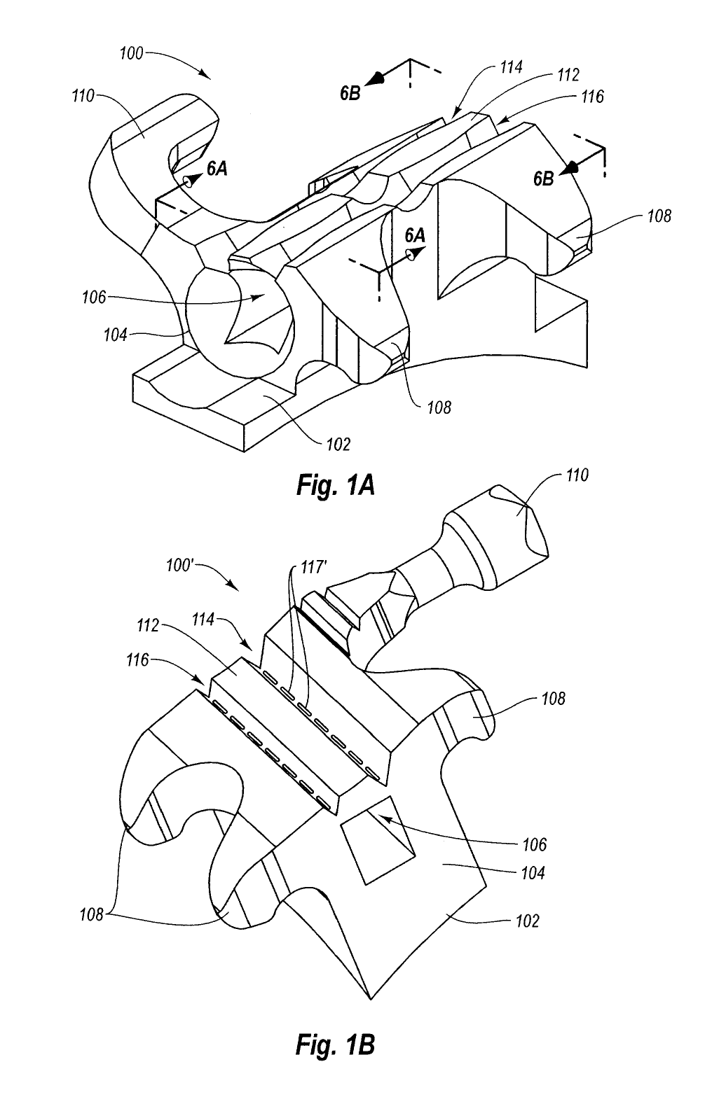

FIGS. 1A-1B illustrate exemplary convertible orthodontic brackets that may be formed according to the present inventive method. FIG. 1A illustrates an exemplary convertible molar tube bracket 100 including a bracket base 102 and a body 104. An arch wire hole 106 is formed so as to extend mesially-distally through body 104. As shown, one or both ends of hole 106 may be flared, making insertion of an arch wire (not shown) into hole 106 easier. Body 104 further includes a plurality of tie wings 108, as well as a curved gingival hook 110. As shown, bracket 100 is convertible in the sense that it includes a labial web cover 112 that is selectively removable, such that the arch wire hole 106 is initially closed on four sides (i.e., the labial, lingual, occlusal, gingival sides) and open at the mesial and distal ends. In the illustrated embodiment, labial web cover 112 is bounded by two web regions 114, 116 of reduced cross-sectional thickness interconnecting cover 112 with portions of body 104 adjacent tie wings 108. By selectively removing labial web cover 112, the practitioner may convert arch wire hole 106 into an arch wire slot that is open along the top labial side.

FIG. 1B illustrates an alternative convertible bracket 100′ configured for placement on a bicuspid. Similar structures of bracket 100′ bear identical reference numerals as those of bracket 100 of FIG. 1A. Besides being configured for placement upon a bicuspid rather than a molar, principal differences relative to bracket 100′ include a straight gingival hook 110 and perforations 117′ through thinned web regions 114 and 116 in order to further facilitate removal of labial web cover 112. In both illustrated embodiments, the arch wire hole 106 is closed on four sides when manufactured. Such a configuration may advantageously be formed by the present inventive machining method, resulting in a stronger, more dense metal bracket body with tighter dimensional tolerances as compared to alternative methods employing metal injection molding.

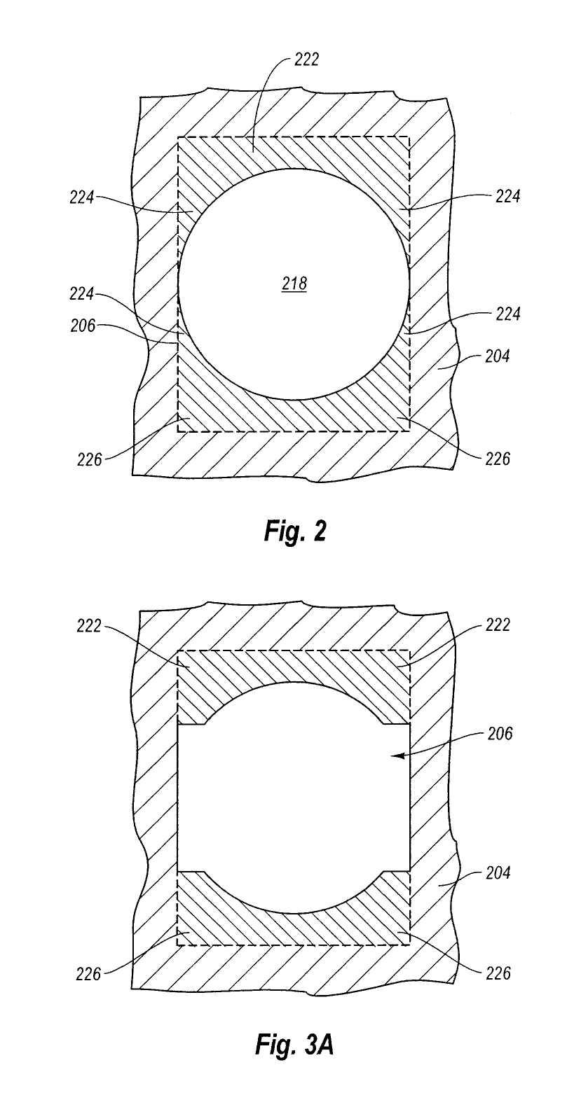

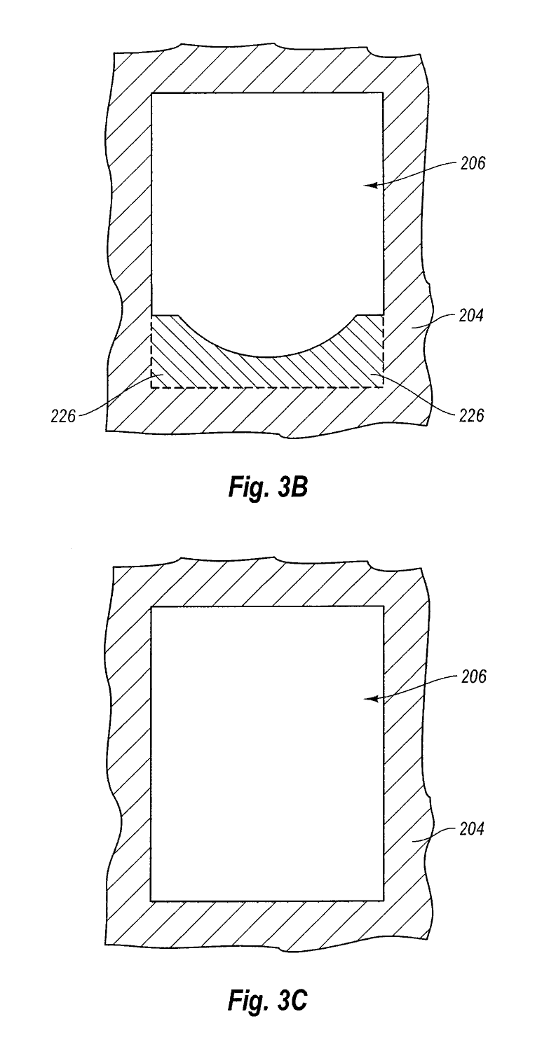

FIGS. 2-3C illustrate an exemplary method by which a rectangular arch wire hole (e.g., hole 106) may be formed through the bracket body. FIG. 2 shows a cross-sectional view through the partially formed bracket body 204. In FIG. 2, a circular pilot hole 218 has been formed through body 204. Pilot hole 218 as illustrated has a diameter equal to the width of the finished arch wire hole 206 (i.e., the sides of finished rectangular hole 206 are tangent to pilot hole 218). Pilot hole 218 may advantageously be formed using a drill bit or an end mill tool of the appropriate diameter (e.g., 0.022 inch or 0.018 inch). An end mill tool is capable of cutting along its side edges, while a drill bit only cuts at its axial end.

As shown in FIG. 3A, a shaping broach is then pushed or pulled through pilot hole 218, removing material 224 along the center portion of the side walls of arch wire hole 206. In the illustrated example, the first shaping broach is centrally disposed and sized to broach about half of the finished arch wire hole 206. As shown in FIG. 3B, a second shaping broach is then pushed or pulled through partially formed arch wire hole 206, removing material 222 (FIG. 3A) along the labial top surface and corners adjacent pilot hole 218. As shown in FIG. 3C, a third shaping broach is then pushed or pulled through the partially formed arch wire hole 206, removing material 226 (FIG. 3B) along the lingual bottom surface and corners adjacent pilot hole 218. The result is the finished rectangular arch wire slot 206. Depending on the dimensions of the shaping broach, a single broach may be used for more than one broaching step. In other words, the same broach may be used to remove the second portion as shown in FIG. 3B, as well as the final third portion as shown in FIG. 3C. The same broach may even be used for all three broaching steps (e.g., (1) broaching the center, (2) broaching the top or bottom, and (3) broaching the portion remaining from (2)). Alternatively, multiple shaping broaches may be used. Use of a single broach may be preferred for increased speed of manufacture (i.e., where it is desired to not change tools engaged within a spindle).

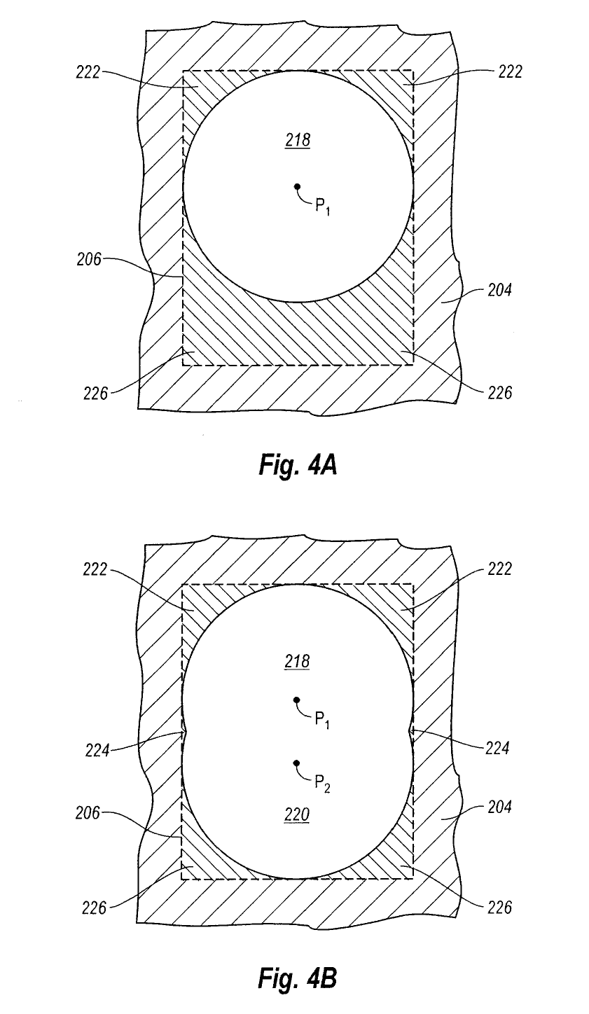

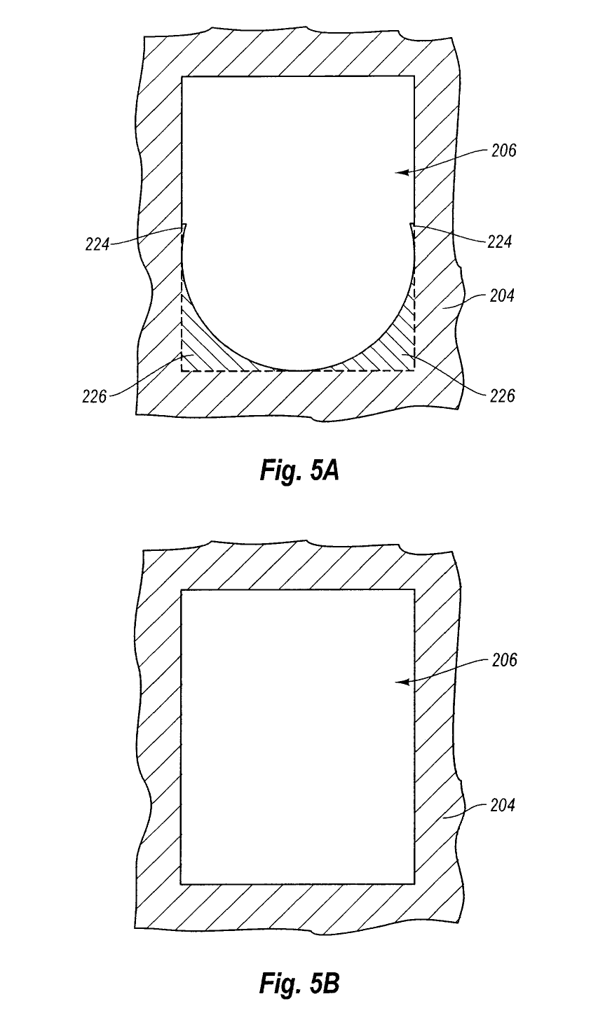

FIGS. 4A-5B illustrate an alternative exemplary method by which a rectangular arch wire hole (e.g., hole 106) may be formed through the bracket body. FIG. 4A shows a cross-sectional view through a partially formed bracket body 204. In FIG. 4A, a first pilot hole 218 has been formed through body 204. Pilot hole 218 as illustrated has a diameter equal to the width of the finished arch wire hole 206. In addition, placement of hole 218 is such that the long sides and short top of finished rectangular hole 206 are tangent to pilot hole 218. First pilot hole 218 may advantageously be formed using a drill bit of the appropriate diameter (e.g., 0.022 inch or 0.018 inch)

As shown in FIG. 4B, a second pilot hole 220 is then formed through body 204. As illustrated, the diameter of second pilot hole 220 may be equal to that of first pilot hole 218, and also equal to the width of finished arch wire hole 206. Placement of second pilot hole 220 may be such that the long sides and short bottom of finished rectangular hole 206 are tangent to pilot hole 220. The axes P₁ and P₂ of first and second pilot holes 218 and 220, respectively, are offset from one another, although in the illustrated configuration, pilot holes 218 and 220 also overlap one another. Because second pilot hole 220 partially overlaps hole 218, second pilot hole 220 may advantageously be formed with an end mill tool used in conjunction with a high frequency spindle. Such a configuration allows formation of the desired hole, even with overlap of the first pilot hole 218.

By way of example, the spindle may operate between about 15,000 and about 160,000 RPM, more preferably between about 25,000 and about 75,000 RPM, and most preferably between about 35,000 and about 45,000 RPM. Use of an end mill and a high frequency spindle will advantageously allow formation of the second pilot hole 220 in an overlapping configuration, as illustrated. Once pilot holes 218 and 220 have been formed, only small portions of metal remain at each corner 222, 226 and near the center 224 of the long sides to be removed to form a finished arch wire hole 206.

As shown in FIG. 5A, a first shaping broach is pushed or pulled through at least one of the pilot holes to begin removal of material 222, 224, and 226 (FIG. 4B). For example, a first broach is pushed or pulled through first pilot hole 218, removing material 222 along the labial corners adjacent first pilot hole 218, as well as a portion of material 224 along the center of the side walls of arch wire hole 206. In the illustrated example (FIG. 5B), a shaping broach (either the same as the first broach or a different broach) is pushed or pulled through the remaining pilot hole 220, removing material 226 (FIG. 5A) along the lingual corners adjacent second pilot hole 220, as well as any remaining material 224 along the center of the side walls of arch wire hole 206. The result is the finished rectangular arch wire hole 206.

The use of drill bits, end mills, and broaches including a carbide coating (e.g., titanium carbide and/or tungsten carbide) is particularly preferred, as they have been found to surprisingly allow formation of tiny pilot holes (e.g., typically less than 0.025 inch diameter) and rectangular finished arch wire holes (e.g., typically having a width less than about 0.025 inch) without breakage of the tools. The ability to form such tiny holes is surprising, as those skilled in the art previously would have expected such manufacturing method to be unworkable as a result of severe tool wear and/or tool breakage.

In addition, it is noted that preferred embodiments of the machining methods involve the formation of multiple pilot holes and/or the use of multiple broaches to finish the desired rectangular cross-sectional shape. The formation of multiple pilot holes has been found to surprisingly reduce overall tool wear as compared to the formation of a single pilot hole followed by broaching. For this reason, embodiments including the formation of multiple pilot holes to remove as much of the material as possible are preferred.

In embodiments where only a single pilot hole is formed, the inventors have found that tool wear is surprisingly reduced beyond what would normally be expected by employing multiple broaching steps. Although this wear reduction is less than when forming multiple pilot holes, it has still been found there is a significant reduction in broach wear when broaching using a two or three step operation (e.g., broaching the center, one end, and then the remaining end) as opposed to attempting to remove all the remaining material in a single broaching step.

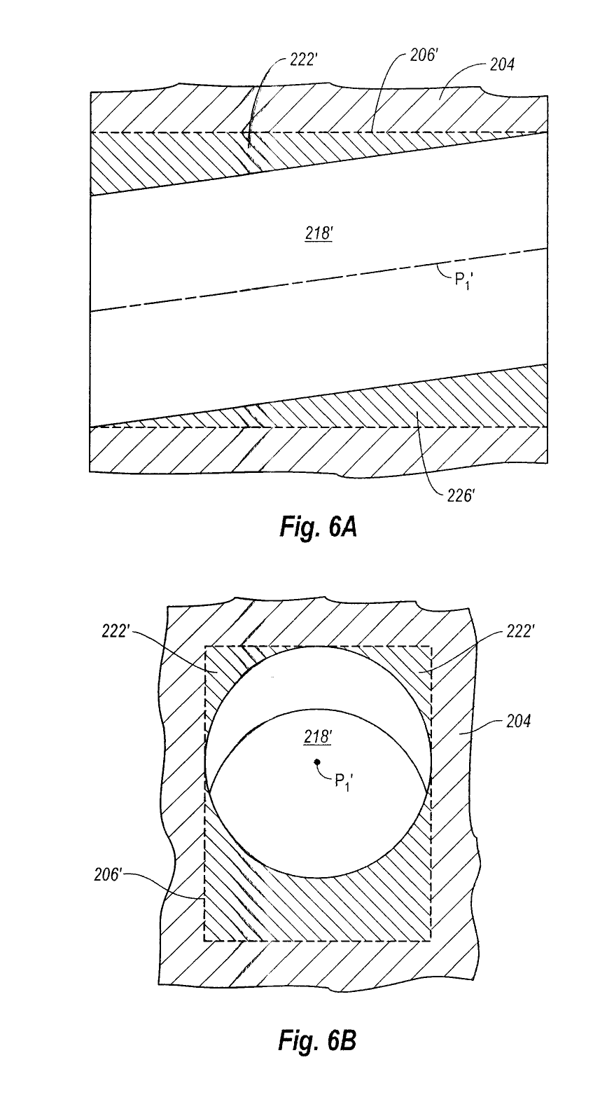

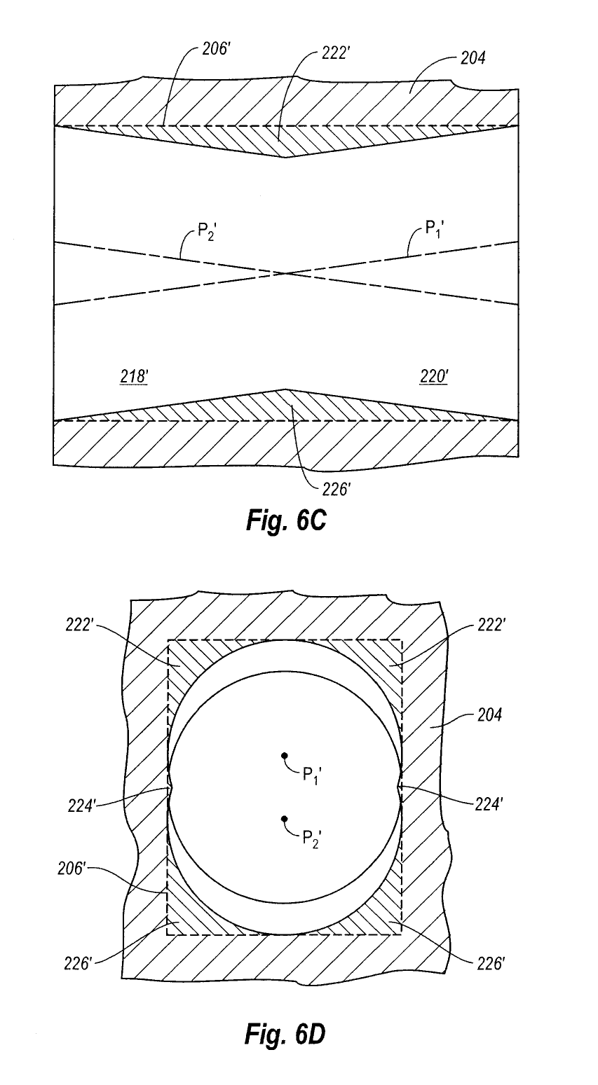

Pilot holes 218 and 220 may be formed parallel to one another. In an alternative embodiment shown in FIGS. 6A-6D, the pilot holes may be angled so that one pilot hole angles from the top labial corner at one end to the bottom lingual corner at the other end. The other pilot hole may be angled so that the pilot holes criss-cross (i.e., the axes P₁ and P₂ cross one another) as they traverse through what will become the arch wire hole. FIG. 6A shows a cross-sectional view taken along a plane defined by the longitudinal axis of the bracket body 204 (i.e., perpendicular to the cross-sectional views of FIGS. 2-5B). As seen in FIGS. 6A-6B, first pilot hole 218′ having axis P₁′ is formed at an angle (e.g., sloping lingually downward). As seen in FIGS. 6C-6D, second pilot hole 220′ along axis P₂′ is formed at an angle (e.g., sloping labially upward) so that axes P₁′ and P₂′ cross one another. The material 222′, 224′, and 226′ remaining after formation of the pilot holes may then be removed by broaching, as described above in conjunction with FIGS. 5A-5B to produce the finished arch wire hole 206′.

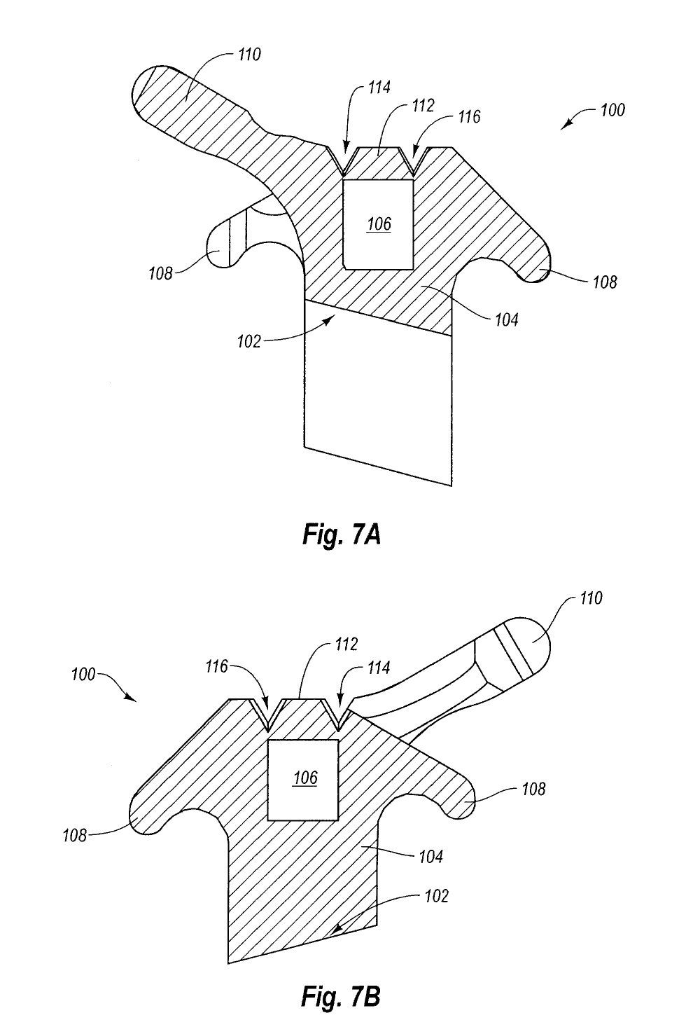

Connecting web regions 114, 116 on either side of peelable labial web cover 112 are also formed by machining (e.g., using an end mill). Because these structures are formed by machining, it is possible to form the connecting web regions 114, 116 so as to include variable thicknesses that change as one moves from the mesial edge towards the distal edge of the connecting web. Such an embodiment is illustrated in FIGS. 7A-7B, which illustrate cross-sections near the mesial edge of bracket 100 and distal edge of bracket 100 respectively. As seen in FIG. 7A, the extreme mesial edge of connecting web regions 114 and 116 may be machined so as to provide a minimum thickness, facilitating easier removal of the labial web cover 112 from the mesial edge. As seen in FIG. 7B, a cross section near the distal edge of connecting web regions 114 and 116 may advantageously be provided with greater thickness, providing an overall level of desired strength to the web cover so as to prevent premature and/or unintentional removal of the web. Providing a variable, tapered thickness as illustrated allows a practitioner to begin peeling away cover 112 at the mesial edge, where web thickness is at a minimum, and continuing towards the thicker distal edge. Such a variable tapered web thickness is difficult, if not a practical impossibility, to form using conventional metal injection molding techniques. For example, such a variable tapered thickness would be impractical with a metal injection molded bracket, as the unpredictable shrinkage associated with the manufacturing process would likely make it difficult or impossible to provide desired dimensional tolerances.

By way of example, the amount of peeling force required to remove the web covers 112 is between about 10 lbs. and about 30 lbs., more preferably between about 12 lbs. and about 28 lbs., and most preferably between about 17 lbs. and about 23 lbs. Commercially available metal injection molded brackets are batch tested as a result of the inability to provide tight dimensional tolerances relative to web thickness. For example, such batch testing results in rejection of batches in which the web removal force is less than 10 lbs or greater than 30 lbs. As a result, a significant quantity of the manufactured brackets must be discarded. Any attempt to metal injection mold a bracket including a variable tapered thickness would be impractical, as the rejection rates would likely be even higher.

By contrast, manufacture by machining allows for significantly improved dimensional tolerances. Such tolerances directly affect the force required for web removal. For example, the machined brackets could easily be price competitive with existing metal injection molded brackets, but include a much narrower range of force required for web removal (e.g., about 17 lbs. to about 23 lbs.). Such an improvement would be appreciated by practitioners, as the bracket's performance would be significantly more predictable.

In addition, machining the brackets rather than metal injection molding allows for use of stronger, more dense metal materials, which materials are not suitable in metal injection molding. Use of stronger, more dense metal materials (e.g., 17-4 and/or 17-7 class stainless steels) provides for a stronger, more dense finished product. In addition, 17-4 and 17-7 class stainless steels may be heat treated after machining to further increase strength. Such heat treatments are not possible using classes of stainless steels suitable for use in metal injection molding. By contrast, metal injection molded brackets are formed from stainless steel powder materials (e.g., 303, 304, and/or 316L class stainless steels) which, although better suited for powderization and sintering, exhibit less strength and lower density compared to 17-4 and 17-7 class stainless steel.

In addition, the strength and density of actual finished brackets formed by metal injection molding are less than the bulk strength and density of metal materials employed as micro air pockets can form during molding and sintering, and the strength of the finished article may be reduced as the sintering process may result in weak bonding of the metal powder. No such issues occur when machining a bulk metal material.

Furthermore, the dimensional tolerances of the machined arch wire hole as well as the connecting web regions are significantly tighter with machined brackets as compared to brackets formed by metal injection molding. For example, when machining the arch wire hole as described, the dimensions of the arch wire hole are carefully controlled. Tighter dimensional tolerances with respect to the arch wire hole result in a better fit with the arch wire, which results in overall faster treatment times. Such control is simply not possible with metal injection molding, where the sintering process results in an unpredictable amount of shrinkage.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of manufacturing a convertible orthodontic bracket, comprising:
forming a circular pilot hole having an axis extending mesially-distally through a body of an orthodontic bracket;
pressing or pulling one or more shaping broaches through the pilot hole so as to form a finished rectangularly-shaped arch wire hole within the orthodontic bracket body;
machining a first connecting web region of a selectively removable labial web cover, the first connecting web region being machined so as to have a reduced cross-sectional thickness extending between a gingival side of the bracket body on one side of the first connecting web region and a thickened central portion of the labial web cover on an opposite side of the first connecting web region; and
machining a second connecting web region of the labial web cover, the second connecting web region being machined so as to have a reduced cross-sectional thickness extending between an occlusal side of the bracket body on one side of the second connecting web region and the thickened central portion of the labial web cover disposed between the first and second connecting web regions.

2. A method as recited in claim 1, wherein the pilot hole has a diameter less than about 0.025 inch.

3. A method as recited in claim 1, wherein the pilot hole has a diameter between about 0.018 inch and about 0.022 inch.

4. A method as recited in claim 1, wherein the finished rectangularly shaped arch wire hole has a width between about 0.018 inch and about 0.022 inch.

5. A method as recited in claim 4, wherein the finished rectangularly shaped arch wire hole has a height of about 0.028 inch.

6. A method as recited in claim 1, wherein the pilot hole has a diameter approximately equal to a width of the rectangular arch wire hole.

7. A method as recited in claim 6, wherein the circular pilot hole is substantially centered relative to the finished rectangular arch wire hole.

8. A method as recited in claim 1, wherein the pilot hole is formed by drilling through the body of the orthodontic bracket with a drill bit comprising at least one of titanium carbide or tungsten carbide.

9. A method as recited in claim 1, wherein the one or more shaping broaches comprise at least one of titanium carbide or tungsten carbide.

10. A method as recited in claim 1, wherein the orthodontic bracket body comprises at least one of 17-4 or 17-7 class stainless steel.

11. An orthodontic bracket as recited in claim 1, wherein the cross-sectional thickness of each connecting web region is tapered so as to be thinner at a mesial edge and thicker at a distal edge of the labial web cover.

12. A method of manufacturing a convertible orthodontic bracket, comprising:
forming a circular pilot hole having an axis extending mesially-distally through the body of an orthodontic bracket;
pressing or pulling a first shaping broach through the pilot hole so as to remove material adjacent to the pilot hole;
pressing or pulling a second shaping broach through the pilot hole so as to remove material adjacent to the pilot hole and form a finished rectangularly shaped arch wire hole;
machining a first connecting web region of a selectively removable labial web cover, the first connecting web region being machined so as to have a reduced cross-sectional thickness extending between a gingival side of the bracket body on one side of the first connecting web region and a thickened central portion of the labial web cover on an opposite side of the first connecting web region; and
machining a second connecting web region of the labial web cover, the second connecting web region being machined so as to have a reduced cross-sectional thickness extending between an occlusal side of the bracket body on one side of the second connecting web region and the thickened central portion of the labial web cover disposed between the first and second connecting web regions.

13. A method as recited in claim 12, wherein the pilot hole has a diameter approximately equal to a width of the rectangular arch wire hole.

14. A method as recited in claim 13, wherein the circular pilot hole is centered relative to the finished rectangular arch wire hole.

15. A method as recited in claim 14, wherein the first shaping broach is pushed or pulled through the body to form a center portion of the finished rectangular arch wire hole.

16. A method as recited in claim 15, wherein the second shaping broach is pushed or pulled through the body to form a labial top portion of the finished rectangular arch wire hole.

17. A method as recited in claim 15, wherein the second shaping broach is pushed or pulled through the body to form a lingual bottom portion of the finished rectangular arch wire hole.

18. A method as recited in claim 17, wherein a third shaping broach is pushed or pulled through the body to form a labial top portion of the finished rectangular arch wire hole.

19. An orthodontic bracket as recited in claim 1, wherein the cross-sectional thickness of each connecting web region is tapered so as to be thinner at a mesial edge and thicker at a distal edge of the labial web cover.

20. A method as recited in claim 1, wherein the orthodontic bracket body comprises at least one of 17-4 or 17-7 class stainless steel.
